(19) United States
(12) Patent Application Publication
(10) Pub. No.: US 2024/0231159 A9
(43) Pub. Date: Jul. 11, 2024

(54) SWITCHABLE FILM, LAMINATED GLAZING, AND METHOD OF PRODUCING SWITCHABLE FILM

(71) Applicant: CARLEX GLASS AMERICA, LLC, Nashville, TN (US)

(72) Inventors: Wladislaw BRONSTEIN, Konz (DE); Jean-Marc SOL, Thionville (FR)

(21) Appl. No.: 18/546,552

(22) PCT Filed: Feb. 22, 2022
(86) PCT No.: PCT/EP2022/054364

§ 371 Date: Aug. 15, 2023

Related U.S. Application Data
(60) Provisional application No. 63/153,827, filed on Feb. 25, 2021.

(30) Foreign Application Priority Data
Feb. 22, 2022 (WO) WO 2022/180021 A1

(51) Int. Cl. G02F 1/1343; B32B 17/10; G02F 1/1334

(52) U.S. Cl. CPC G02F 1/134309; B32B 17/10036; B32B 17/10504; B32B 17/10532; B32B 17/10605; B32B 17/10761; B32B 17/10788; G02F 1/1334; B60J 1/001

(57) ABSTRACT

A switchable film sequentially includes a first substrate; a first conductive layer; a switchable material layer; a second conductive layer; and a second substrate. The first substrate includes a first cut out portion wherein the first cut out portion aligns entirely with the second substrate. A first busbar is formed on the first conductive layer on the first substrate and a second busbar is formed on the second conductive layer on the second substrate within the first cut out portion of the first substrate. A first barrier is positioned around the first cut out portion of the first substrate.

### CROSS REFERENCE TO RELATED APPLICATIONS

This application claims priority to U.S. Provisional Application No. 63/153,827 filed on Feb. 25, 2021, entitled “Switchable Film and Laminated Glazing with such a Film”, the entire contents of which are incorporated by reference herein in their entirety.

### TECHNICAL FIELD

The present disclosure is generally related to a switchable film having busbars and a barrier and laminated glazings having such a film therein.

### BACKGROUND

Switchable films in glass constructions may be provided for various purposes, including architectural and vehicle windows. Switchable films may include those based on liquid crystal constructions and may be selectively changed from an opaque or dark state to a transparent, or clear, state by the application of an electric field to the film. The electrical connection may be formed within the glass construction to control the switchable material. When an electric field is activated, the switchable material may transfer from an opaque state to a transparent state or vice versa.

Switchable materials may include polymer dispersed liquid crystal (PDLC) and polymer network liquid crystal (PNLC) constructions. PDLC materials are formed by liquid crystals dispersed throughout a liquid polymer matrix. As the polymer matrix solidifies, the liquid crystals form droplets. The random orientation of liquid crystal droplets results in the opaque, milky appearance of the PDLC in an OFF state. When an electrical current is applied to the PDLC, the liquid crystals may align parallel to the direction of the electric field. The parallel orientation allows for light to pass through, and in an ON state, PDLC is transparent relative to the OFF state. PNLC may also provide a film that may selectively switch between opaque and transparent states. PNLC films may have a higher ratio of liquid crystal to polymer and require a lower driving voltage than a PDLC. Liquid crystal films may also be configured to have a reverse alignment where, in a default OFF state, the liquid crystal film is transparent, and in an ON state with an electric voltage applied, the liquid crystal film is opaque.

Over time, such switchable materials may show signs of deterioration, particularly at a periphery of the material. The liquid crystal material may be affected by introduction of contaminants such as moisture or plasticizers present in a surrounding adhesive layer. Time and other elements, such as heat, may impact migration of the contaminants into the switchable liquid crystal layer and the effect of such migration. The contamination may result in clearing of the film, which may begin in a periphery edge portion of the film. Over time, the clearing may extend further into the film and provide an area of the film that loses opacity. For example, a PDLC film that is opaque in an OFF state may have a cleared portion which appears relatively less opaque. The clearing at edges of the film is undesirable and may affect the aesthetic quality of a glazing having such a switchable film. There is a need in the art for a suitable barrier to such contaminants such that a switchable film may be suitable for lamination.

### SUMMARY OF THE DISCLOSURE

Although a glass construction including a switchable film may have a peripheral portion coated by a black paint (an opaque paint), or other opaque print, and a central portion where the liquid crystal layer is visible, an undesirable cleared portion may reach the central portion and may be visible. Any area where the liquid crystal layer of the switchable film may be exposed to interlayers and possible contaminants within the laminated glazing, including an area around any busbars, may be of concern and considered for protection, including with a barrier. In order to allow flexibility of a glass construction design, the present disclosure includes a switchable film including new structure related to the busbar.

Disclosed herein is a switchable film, sequentially including: a first substrate; a first conductive layer; a switchable material layer; a second conductive layer; and a second substrate. The first substrate includes a first cut out portion wherein the first cut out portion aligns entirely with the second substrate. A first busbar is formed on the first conductive layer on the first substrate and a second busbar is formed on the second conductive layer on the second substrate within the first cut out portion of the first substrate. A first barrier is positioned around the first cut out portion of the first substrate.

In some embodiments of the present disclosure, the second substrate may include a second cut out portion. The second cut out portion may align entirely with the first substrate. The first busbar may be formed within the second cut out portion of the second substrate. A third barrier may be positioned around the second cut out portion of the second substrate.

In some embodiments of the present disclosure, a second barrier may be positioned around the first substrate, the switchable material layer and the second substrate. The first and second substrates may be substantially the same size. The first substrate and the second substrate may be in contact and an edge of the switchable material layer may be positioned within a point of contact of the first substrate and the second substrate. The second barrier may be positioned around the point of contact.

In some embodiments of the present disclosure, the second substrate may be smaller than the first substrate such that the first substrate extends beyond the second substrate along an entire edge of the second substrate. A second barrier may be positioned around the second substrate and the switchable material layer.

In some embodiments of the present disclosure, the switchable material layer may be a liquid crystal material. The switchable material may be a polymer dispersed liquid crystal.

In some embodiments of the present disclosure, the first busbar and the second busbar may each have a width in the range of 4 mm to 8 mm.

In some embodiments of the present disclosure, the first barrier may each have a width of from 2 mm to 8 mm. In some embodiments of the present disclosure, the first barrier may be a tape.

In some embodiments of the present disclosure, the first barrier may be a resin. The resin may be a cured product of a multiple component material. The resin may be a cured product of an ultraviolet curable material or a thermally curable material. The resin may be a solidified thermoplastic material.

In some embodiments of the present disclosure, the first busbar and the second busbar may be aligned along the same edge of the switchable film. The first busbar and the second busbar may run parallel to each other.

In some embodiments of the present disclosure, the first cut out portion of the first substrate may have a width of from 10 mm to 15 mm.

In some embodiments of the present disclosure, the switchable film may further include first connector attached to the first busbar and a second connector attached to the second busbar.

In another aspect of the present disclosure, a laminated glazing includes: a first glass sheet; a first adhesive interlayer; the switchable film of the present disclosure; a second adhesive interlayer; and a second glass sheet.

Some embodiments of the present disclosure may further include: a third adhesive interlayer positioned between the first and second adhesive interlayers around the switchable film to compensate for a thickness change that would otherwise occur at the switchable film edge. The first, second, and third adhesive interlayers may be combined.

In another aspect of the present disclosure, a method of producing a switchable film includes: preparing a laminate film sequentially including: a first substrate; a first conductive layer; a switchable material layer; a second conductive layer; and a second substrate, locally removing the first substrate, the first conductive layer, and the switchable material layer to expose the second conductive layer on the second substrate and form a first cut out portion aligned entirely with the second substrate, forming a first busbar on the first conductive layer on the first substrate, forming a second busbar on the second conductive layer on the second substrate within the first cut out portion of the first substrate, and applying a barrier material to around the first cut out portion.

In some embodiments of the present disclosure, the barrier material may be a liquid resin. The liquid resin may be a multiple component material which cures upon application of the multiple components. The liquid resin may be an ultraviolet light curing material or a thermal curing material. The liquid resin may be a thermoplastic material.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates an undesirable switchable film construction.

FIG. 2 illustrates a switchable film according to an exemplary embodiment of the present disclosure.

FIG. 3 illustrates a switchable film according to an exemplary embodiment of the present disclosure.

FIG. 4 illustrates a switchable film according to an exemplary embodiment of the present disclosure.

FIG. 5 illustrates a switchable film according to an exemplary embodiment of the present disclosure.

FIG. 6 illustrates a switchable film according to an exemplary embodiment of the present disclosure.

FIG. 7 illustrates a cross section of a switchable film according to an exemplary embodiment of the present disclosure.

FIG. 8 illustrates a cross section of a switchable film according to an exemplary embodiment of the present disclosure.

FIG. 9 illustrates a cross section of the switchable film according to an exemplary embodiment of the present disclosure.

FIG. 10 illustrates a cross section of the switchable film according to an exemplary embodiment of the present disclosure.

FIG. 11 illustrates a cross section of the switchable film according to an exemplary embodiment of the present disclosure.

FIG. 12 illustrates a cross section of a laminated glazing having a switchable film therein according to an exemplary embodiment of the present disclosure.

FIG. 13 illustrates a cross section of a laminated glazing having a switchable film therein according to an exemplary embodiment of the present disclosure.

### DETAILED DESCRIPTION

In the following description, for purposes of explanation, specific details are set forth in order to promote a thorough understanding of one or more aspects of the disclosure. It may be evident in some or all instances, however, that any aspects described below can be practiced without adopting the specific design details described below.

This disclosure relates generally to a switchable film and a barrier to protect a switchable material in the film from contamination, a laminated glazing having such a switchable film laminated therein, and a method of producing such a switchable film.

A laminated glazing having a switchable function may typically include a first glass sheet, a first adhesive interlayer, a switchable film, a second adhesive interlayer, and a second glass sheet. The first and second glass sheets may include any suitable glass, and may preferably include a soda-lime silicate glass, such as that described by ISO 16293-1:2008. The glass sheets may be bent to a desired shape prior to lamination, which may include heating the glass sheets to a temperature from 560° C. to 700° C., more preferably from 600° C. to 660° C. The first and second adhesive interlayers may include a polymer adhesive material, such as polyvinyl butyral (PVB) or any other suitable laminating material, including ethylene vinyl acetate (EVA) or ionomers. In the laminated glazing, first and second adhesive interlayers may be combined after the autoclaving process and the boundary thereof may be indistinguishable. As used herein, an adhesive interlayer located between the first glass sheet and the switchable film may be called the first adhesive interlayer, and an adhesive interlayer located between the second glass sheet and the switchable film may be called the second adhesive interlayer.

An adhesive interlayer may include plasticizers which enable use of the interlayer. The plasticizers may include, for example, esters, including triethylene glycol di(2-ethyl hexanoate), triethylene glycol di(2-ethyl butyrate), bis(2-ethylhexyl)phthalate, bis(2-ethylhexyl)adipate, dihexyl adipate, dioctyl adipate, diisononyl adipate, diisodecyl adipate, diisononyl phthalate, tris(2-ethylhexyl) trimellitate.

The switchable film may sequentially include a first substrate, a first conductive layer, a switchable material layer, a second conductive layer, and a second substrate. Particularly, the first and second substrates may include a polymer film, such as polyethylene terephthalate (PET). The first and second conductive layers may provide electrodes for turning the switchable material layer on and off and may include a transparent metal oxide, such as indium tin oxide or zinc oxide. The first conductive layer may be formed on the first substrate and the second conductive layer may be formed on the second substrate. The switchable material layer may preferably include a liquid crystal material, such as a polymer dispersed liquid crystal (PDLC) or a polymer networked liquid crystal (PNLC), a fine particle material, such as a suspended particle device (SPD), or any other functional switchable film.

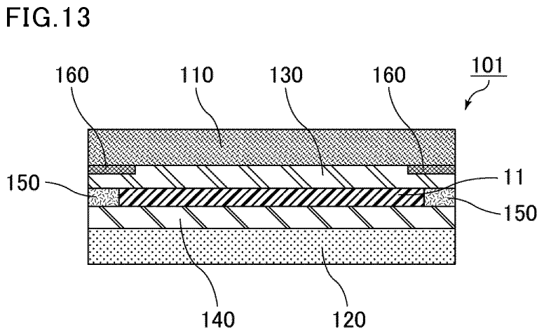

According to embodiments of the present disclosure, a barrier may be provided on a switchable film to protect a switchable material layer from contaminants, including moisture and plasticizers. The barrier may be a material such that contaminants are blocked from reaching the switchable material and may be positioned at an edge of the switchable material. Preferably, a switchable film does not reach the edge of a laminated glazing. The conductive layers within the switchable film may be preferably kept from a glazing edge to prevent corrosion from occurring and to prevent delamination of the materials. It may further be preferable that the film does not extend to the glazing edge to avoid wrinkles which may be likely to form in the film at a glazing edge having strong curvature. Thus, the edge of the switchable film may be positioned between the first and second adhesive interlayers within the laminated glazing. An opaque print may be provided in a periphery of the laminated glazing which may hide the switchable film edge from view (see FIG. 13).

In some embodiments, there may further be a third adhesive interlayer positioned between the first and second adhesive interlayers around the switchable film to compensate for a thickness change that would otherwise occur at the switchable film edge (see FIG. 13). Where the switchable film has a thickness of from about 0.25 mm to about 0.55 mm, a third adhesive interlayer may have a thickness of from about 0.25 mm to about 0.55 mm, preferably from about 0.33 mm to about 0.45 mm. Where the switchable film has a thickness of 0.25 mm or less, there may or may not be a third adhesive interlayer around the edge of the switchable film. Where the switchable film edge is exposed to the adhesive interlayers, there may be a migration pathway through which contaminants, including plasticizers in the adhesive interlayers, may reach the switchable material layer of the film. Thus the barrier may be preferably provided at the edge of the switchable material within the laminated glazing to provide a separation of the switchable material layer of the film and the adhesive interlayer material.

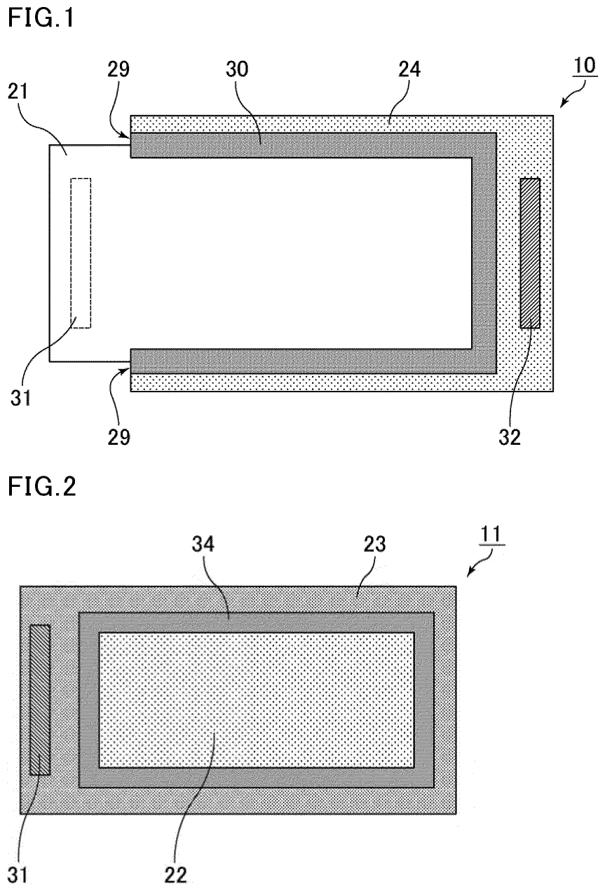

To provide a barrier meeting technical and process needs, a barrier may be preferably provided contacting both the first and second substrate and/or conductive layer from one side of the switchable film. Further, a busbar may be formed on each conductive layer of the switchable film for connection to a power source. To facilitate such a barrier construction, one substrate and conductive layer may extend beyond the other substrate and conductive layer as shown in FIG. 1. FIG. 1 illustrates an undesirable switchable film construction. In FIG. 1, a switchable film 10 has a first substrate 21 and a second substrate. A second busbar 32 is formed above the second conductive layer 24 on the second substrate. A first busbar 31 is formed below the first substrate 21 relative to the view shown in FIG. 1, on a first conductive layer on the first substrate 21. The position of the first busbar 31 is shown as an area surrounded by a dotted line. FIG. 1 also shows a barrier 30 on the first substrate 21 and the second conductive layer 24.

Such a construction, however, may produce a corner 29 between the first substrate 21 and second substrate. The barrier 30, as described above, may not be properly formable at such a corner 29 and may cause a barrier edge to be formed. Such a corner 29 may not be suitable and may provide a pathway for contaminants to reach the switchable material when laminated in a glazing. A preferable form of the switchable film may be provided herein where the barrier layer may be provided without such an edge.

In some embodiments, a switchable film herein may include first and second substrates which are different sizes such that the second substrate may fit within the first substrate. Particularly, the first substrate and the first conductive layer may extend beyond the entire edge of the second substrate and the second conductive layer, as shown in FIG. 2.

FIG. 2 illustrates a switchable film according to an exemplary embodiment of the present disclosure. FIG. 2 shows a view from main surface of the second substrate 22.

A switchable film 11 may include a first substrate 21 and a second substrate 22. The second substrate 22 may be smaller than the first substrate 21 such that the first substrate 21 extends beyond the second substrate 22 along an entire edge of the second substrate 22. A first busbar 31 may be formed on the first conductive layer 23 on the first substrate 21. A second barrier 34 may be positioned around the second substrate 22 and the switchable material layer. The entire edge of the second substrate 22 may be covered with the second barrier 34. The second barrier 34 may particularly be in contact with both the first conductive layer 23 and the second substrate 22 around the edge of the switchable material layer. Where the first substrate 21 and the second substrate 22 are different sizes, the distance between the edge of the first substrate 21 and the edge of the second substrate 22 may be at least 2 mm and may preferably be from 2 mm to 8 mm around a majority of the first substrate 21. The distance may be measured as a shortest distance between a point on the edge of the first substrate 21 and the edge of the second substrate 22. The distance may be different around the switchable film such that some areas of the film may have a larger or smaller distance compared to other areas. In an area of the first busbar 31, the distance between the edge of the first substrate 21 and the edge of the second substrate 22 may be larger to accommodate the first busbar 31. Preferably, the first busbar 31 may have a width of from 4 mm to 8 mm, more preferably from 5 mm to 6 mm. Preferably the first busbar 31 is positioned at least 1 mm to 2 mm from the second barrier 34. The first busbar 31 may be completely formed on the first conductive layer 23 so that it does not align with the second substrate 22. That is, the first busbar 31 may preferably be formed in an area not aligned with the second substrate 22.

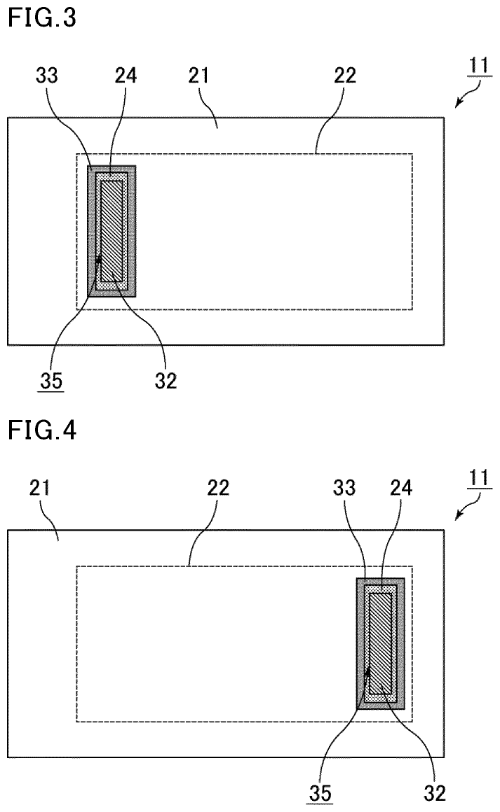

As the second substrate 22 fits entirely within the bounds of the first substrate 21, a solution must be found to access the second conductive layer on the second substrate 22 for application of a second busbar 32. Access may be made by providing a first cut out portion 35 in the first substrate 21 and the first conductive layer aligned with the second substrate 22 and second conductive layer, as shown in FIGS. 3 and 4. The switchable material layer may also be removed from the first cut out portion 35 of the first substrate 21 to expose the second conductive layer on the second substrate 22. The first barrier 33 may be applied at the edge of the first cut out portion 35, protecting the switchable material from exposure. The first cut out portion 35 may have a width of at least 10 mm to 15 mm to accommodate the second busbar 32 and the first barrier 33. The first cut out portion 35 may be positioned in any suitable location on the switchable film, as shown in FIGS. 3 and 4. Some particular embodiments may include a first side as shown in FIG. 2 and a second side as shown in FIG. 3 or FIG. 4. In some embodiments, the first busbar 31 and second busbar 32 may run parallel to each other. Preferably, the second busbar 32 may have a width of from 4 mm to 8 mm, more preferably from 5 mm to 6 mm. Preferably the second busbar 32 is positioned at least 1 mm to 2 mm from the first barrier 33.

FIGS. 3 and 4 illustrate a switchable film according to an exemplary embodiment of the present disclosure. Each of FIGS. 3 and 4 show a view from main surface of the first substrate 21. The position of the second substrate 22 is shown as an area surrounded by a dotted line. The first substrate 21 may include a first cut out portion 35. The first cut out portion 35 may align entirely with the second substrate 22. A first barrier 33 may be positioned around the first cut out portion 35 of the first substrate 21. A second busbar 32 may be formed on the second conductive layer on the second substrate 22 within the first cut out portion 35 of the first substrate 21.

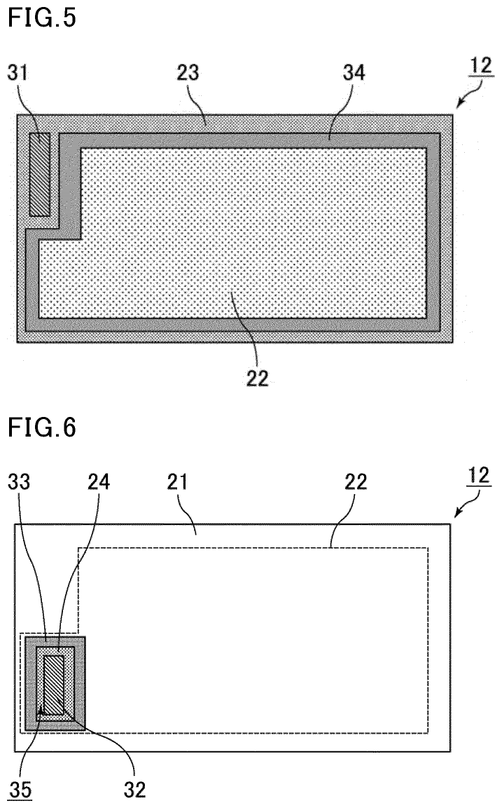

FIGS. 5 and 6 illustrate a switchable film 12 according to an exemplary embodiment of the present disclosure. FIG. 5 shows a view from main surface of the second substrate 22. FIG. 6 shows a view from main surface of the first substrate 21.

In some embodiments, the first busbar 31 and the second busbar 32 may be aligned along the same edge of the switchable film 12, as shown in FIGS. 5 and 6.

In the present disclosure, the first busbar and the second busbar may be in any suitable configuration in relation to one another.

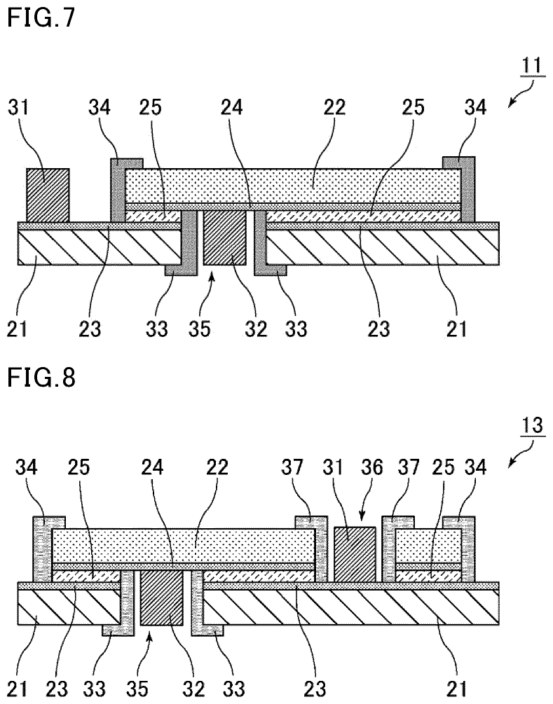

FIG. 7 illustrates a cross section of a switchable film according to an exemplary embodiment of the present disclosure.

The switchable film 11 may sequentially include the first substrate 21, a first conductive layer 23, a switchable material layer 25, a second conductive layer 24, and the second substrate 22. The first busbar 31 may be formed on the first conductive layer 23 on the first substrate 21. The second busbar 32 may be formed on the second conductive layer 24 on the second substrate 22 within the first cut out portion 35 of the first substrate 21. The second barrier 34 may be positioned around the second substrate 22, the second conductive layer 24, and the switchable material layer 25. The first barrier 33 may be positioned around the first cut out portion 35 of the first substrate 21.

FIG. 8 illustrates a cross section of a switchable film according to an exemplary embodiment of the present disclosure.

A switchable film 13 may sequentially include the first substrate 21, the first conductive layer 23, the switchable material layer 25, the second conductive layer 24, and the second substrate 22, as shown in FIG. 8. The second substrate 22 may include a second cut out portion

36. The second cut out portion 36 may align entirely with the first substrate 21. The first busbar 31 may be formed within the second cut out portion 36 of the second substrate 22. A third barrier 37 may be positioned around the second cut out portion 36 of the second substrate 22.

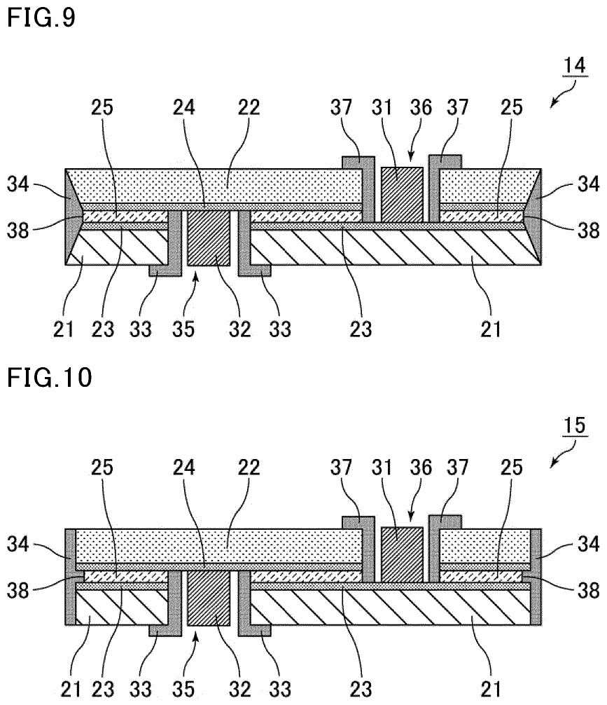

FIG. 9 illustrates a cross section of a switchable film according to an exemplary embodiment of the present disclosure.

A switchable film 14 may sequentially include the first substrate 21, the first conductive layer 23, the switchable material layer 25, the second conductive layer 24, and the second substrate 22, as shown in FIG. 9. The switchable film herein may include first and second substrates which are substantially the same size. The first busbar 31 may be formed on the first conductive layer 23 on the first substrate 21 within the second cut out portion 36 of the second substrate 22. The second busbar 32 may be formed on the second conductive layer 24 on the second substrate 22 within the first cut out portion 35 of the first substrate 21. The second barrier 34 may be positioned around the first substrate 21, a first conductive layer 23 a switchable material layer 25, a second conductive layer 24, and second substrate 22. The switchable film 14 may have a recess 38 around the switchable film 14. The second barrier 34 may fit within the recess 38. The first barrier 33 may be positioned around the first cut out portion 35 of the first substrate 21. The third barrier 37 may be positioned around the second cut out portion 36 of the second substrate 22.

FIG. 10 illustrates a cross section of a switchable film according to an exemplary embodiment of the present disclosure.

In FIG. 10, the switchable film 15 has similar configuration as the switchable film 14 shown in FIG. 9, except the shape of the recess around the switchable film. The recess 38 may be formed in the switchable material layer 25 by reducing the size of the switchable material layer 25. The second barrier 34 may fit within the recess 38. The first conductive layer 23 and the second conductive layer 24 may not directly contact each other to remain electrically isolated from one another.

In some embodiments, the size of the switchable material layer may have substantially the same size as the first substrate, a first conductive layer, a second conductive layer and the second substrate, without a recess 38.

FIG. 11 illustrates a cross section of a switchable film according to an exemplary embodiment of the present disclosure.

In FIG. 11, the switchable film 16 has similar configuration as the switchable film 14 shown in FIG. 9, except for the peripheral shape of the switchable film. The first substrate 21 and the second substrate 22 may be in contact around the first conductive layer 23, the switchable material layer 25, and the second conductive layer 24. The edge of the switchable material layer 25 may located within the point of contact 39 of the first substrate 21 and the second substrate 22. The second barrier 34 may be positioned around the point of contact 39. Preferably, the second barrier 34 may be a metal tape around the point of contact 39. The first substrate 21 and the second substrate 22 may be directly combined by heat sealing. The first substrate 21 and the second substrate 22 may be combined via adhesive. The first and second conductive layers 23, 24 may be cutaway with the switchable material layer 25 between them so that there is no electrical contact between the first conductive layer 23 and the second conductive layer 24.

Generally, the barrier material for forming each barrier may be applied in any suitable form, such as a tape or a liquid. A tape barrier may include an adhesive layer on the tape for adhering to the switchable film. Each of the first barrier, the second barrier, and the third barrier may be a tape. The tape barrier may be metal tape.

In some embodiments, the barrier may be a resin. Each of the first barrier, the second barrier, and the third barrier may be a resin. The resin may be a cured product of a multiple component material. For example, a two-component material which may cure upon application of the two components is preferably used. Further examples may include ultraviolet light, moisture, or thermal curing, elastomer (rubber), or a coated barrier materials. Preferably, the resin may be a cured product of an ultraviolet curable material or a thermally curable material. The resin may be a solidified thermoplastic material. The thermoplastic material may be used as a barrier in some embodiments. The thermoplastic material may be moldable at elevated temperatures and become solid when the temperature is reduced. Examples of the resin may include at least one of an epoxy resin and an acrylic resin. The barrier may be applied to the switchable film before or after the busbars are formed on the conductive layers. Each of the first barrier, the second barrier, and the third barrier may preferably have a width of from 2 mm to 8 mm, more preferably 3 mm to 6 mm.

Some switchable films may be provided having more than one electrically isolated portion. Such a film may have deletions in a conductive layer which provide for the electrically isolated portions. In such a film, each isolated portion may require a separate busbar. It may be preferable that embodiments of the present disclosure having electrically isolated switchable portions may include the isolation deletions on the first conductive layer such that multiple busbars are provided on the first conductive layer. The second conductive layer may remain without electrically isolated portions and require a single busbar and the switchable film may require only one cut out in the first substrate. In some embodiments, where the second conductive layer has one busbar, the busbar may preferably be positioned centrally to the electrically isolated portions of the first conductive layer on the switchable film. Some films may have deletions on both conductive layers and may each have multiple busbars.

The switchable films described herein may further include first and second connectors applied to the busbars. Each connector may be in electrical contact with a busbar but may not be in contact with the conductive layers directly. The second connector may extend over the edge of the cut out portion of the first substrate and the first conductive layer. The barrier may be positioned over such an edge and may electrically insulate the first conductive layer from the second connector.

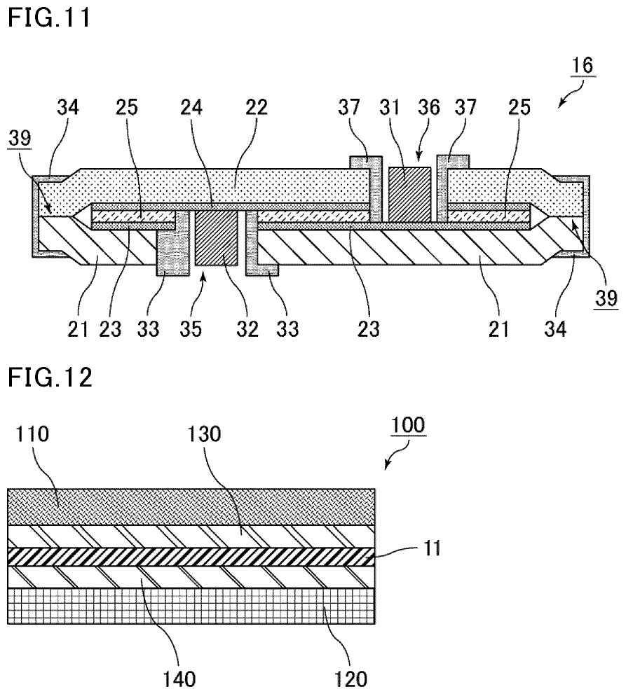

FIGS. 12 and 13 illustrate a cross section of a laminated glazing having a switchable film therein according to an exemplary embodiment of the present disclosure.

FIG. 12 illustrates a portion of a laminated glazing 100. A laminated glazing 100 may include a first glass sheet 110, a first adhesive interlayer 130, the switchable film 11 according to the present disclosure, a second adhesive interlayer 140, and a second glass sheet 120. The switchable film 11 may be laminated in the laminated glazing 100 between first adhesive interlayer 130 and second adhesive interlayer 140 positioned between first glass sheet 110 and second glass sheet 120, as shown in FIG. 12. The illustrated switchable film 12, 13, 14, 15 or 16 may also be used as the switchable film in the laminated glazing of the present disclosure.

In FIG. 13, a laminated glazing 101 may include a third adhesive interlayer 150 positioned between the first adhesive interlayer 130 and second adhesive interlayer 140 around the switchable film 11 to compensate for a thickness change that would otherwise occur at the switchable film edge. Further, the first adhesive interlayer 130, second adhesive interlayer 140, and third adhesive interlayer 150 may be combined in the laminated glazing 101. As shown in FIG. 13, the laminated glazing 101 may further include an opaque layer 160, which may include, for example, an opaque enamel frit printed onto the first glass sheet 110 and/or the second glass sheet 120. The opaque layer 160 may be provided, for example, at a periphery of the laminated glazing 101.

Some glazings may further include an opaque layer in other parts of the glazing, such as a divider through the middle of the glazing. The busbars and barriers may be positioned along an edge of the glazing or any other suitable position. For example, a busbar may be positioned in an area of the glazing having the opaque layer divider. In the laminated glazing, the busbars and barriers on the switchable film may be aligned with the opaque layer such that the busbars and barrier may not be visible when installed in a vehicle.

Further disclosed herein is a method of producing a switchable film which may include: preparing a laminate film sequentially including: a first substrate; a first conductive layer; a switchable material layer; a second conductive layer; and a second substrate, locally removing the first substrate, the first conductive layer, and the switchable material layer to expose the second conductive layer on the second substrate and form a first cut out portion to be aligned entirely with the second substrate, forming a first busbar on the first conductive layer on the first substrate, forming a second busbar on the second conductive layer on the second substrate within the first cut out portion of the first substrate, and applying a barrier material to around the first cut out portion and around the second substrate and the switchable material layer.

In some embodiments of the present disclosure, the barrier material may be a liquid resin. The liquid resin may be a multiple component material which cures upon application of the multiple components. The multiple component material may be two-component material. The liquid resin may be an ultraviolet light curing material or a thermal curing material. The liquid resin may be a thermoplastic material. Examples of the resin may include at least one of an epoxy resin and an acrylic resin.

In some embodiments of the method, the switchable material layer may be exposed in the cut out portion. When the barrier material is a liquid resin, it may be possible to cover the corner of the cut out portion effectively with the liquid resin. Thus, a pathway for contaminants to reach the switchable material may be effectively prevented. The liquid resin may be provided on the cut out portion by dispenser. The liquid resin may be cured by ultraviolet light or heat.

In some embodiments of the method, the switchable film may be provided without an exposed conductive layer, such that the conductive layer(s) must be exposed prior to applying a busbar thereon. Particularly, exposing the first conductive layer in an area for application of the first busbar may include removing the second substrate, a second conductive layer and switchable material layer to expose the first conductive layer. Removal may include cutting away the second substrate and a second conductive layer. The switchable material layer may remain on the first conductive layer during the first busbar application. In some embodiments, the surface of the first conductive layer may be cleaned by wiping with alcohol to remove the switchable material layer, leaving the first conductive layer ready for the first busbar application. The second conductive layer may be similarly prepared for the second busbar by the local removal of the first substrate, the first conductive layer and the switchable material layer. The method may be applied for producing the switchable film having second substrate being smaller size than that of the first substrate, illustrated in FIGS. 2 to 7, or a switchable film having first and second substrates being substantially the same size, illustrated in FIGS. 8 to 11.

The switchable film may be further laminated between first and second glass sheets. The switchable film may, for example, be laminated in an automotive glazing, such as a sunroof, a rear window, side window, or windshield. The lamination process may include stacking the glass sheets, interlayers, and switchable film to provide a lamination stack where the switchable film is positioned between the first and second interlayers which are positioned between the first and second glass sheets. The busbars and connectors may be positioned on the conductive layers of the switchable film prior to lamination. The lamination process may include deairing the lamination stack to remove air from between the materials of the lamination stack. After deairing, the stack may be autoclaved, which includes applying heat and pressure (such as 110° C. to 160° C. and 1 to 1.5 MPa) to the lamination stack to provide a laminated glazing. Connectors attached to the switchable film may extend out of the glazing edge such that they can be connected to a power source outside of the glazing.

In a laminated glazing, the switchable film may be smaller than the first and second glass sheets in terms of surface area so that there is a distance between the edge of the laminated glazing and the edge of the switchable film within the glazing. Preferably, where a switchable film has a thickness of at least 0.25 mm, the laminated glazing may further include a third interlayer around the edge of the switchable film such that there is minimal to no change in thickness where the switchable film ends.

The above description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Further, the above description in connection with the drawings describes examples and does not represent the only examples that may be implemented or that are within the scope of the claims.

Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein

1. A switchable film, sequentially comprising:
a first substrate;
a first conductive layer;
a switchable material layer;
a second conductive layer; and
a second substrate,
wherein the first substrate includes a first cut out portion wherein the first cut out portion aligns entirely with the second substrate;
wherein a first busbar is formed on the first conductive layer on the first substrate and a second busbar is formed on the second conductive layer on the second substrate within the first cut out portion of the first substrate, and
wherein a first barrier is positioned around the first cut out portion of the first substrate.

2. The switchable film according to claim 1, wherein the second substrate is smaller than the first substrate such that the first substrate extends beyond the second substrate along an entire edge of the second substrate and wherein a second barrier is positioned around the second substrate and the switchable material layer.

3. The switchable film according to claim 1, wherein the second substrate includes a second cut out portion; wherein the second cut out portion aligns entirely with the first substrate; wherein
the first busbar is formed within the second cut out portion of the second substrate; and wherein
a third barrier is positioned around the second cut out portion of the second substrate.

4. The switchable film according to claim 1, wherein a second barrier is positioned around the first substrate, the switchable material layer, and the second substrate.

5. The switchable film according to claim 4, wherein the first and second substrates have substantially same sizes.

6. The switchable film according to claim 4, wherein the first substrate and the second substrate are in contact and an edge of the switchable material layer is positioned within a point of contact of the first substrate and the second substrate, and wherein the second barrier is positioned around the point of contact.

7. The switchable film according to claim 1, wherein the switchable material layer is a liquid crystal material.

8. The switchable film according to claim 7, wherein the switchable material layer is a polymer dispersed liquid crystal.

9. The switchable film according to claim 1, wherein the first busbar the second busbar each have a width in the range of 4 mm to 8 mm.

10. The switchable film according to claim 1, wherein the first barrier has a width of from 2 mm to 8 mm.

11. The switchable film according to claim 1, wherein the first barrier is a tape.

12. The switchable film according to claim 1, wherein the first barrier is a resin.

13. The switchable film according to claim 12, wherein the resin is a cured product of a multiple component material.

14. The switchable film according to claim 12, wherein the resin is a cured product of an ultraviolet curable material or a thermally curable material.

15. The switchable film according to claim 12, wherein the resin is a solidified thermoplastic material.

16. The switchable film according to claim 1, wherein the first busbar and the second busbar are aligned along the same edge of the switchable film.

17. The switchable film according to claim 1, wherein the first busbar and the second busbar run parallel to each other.

18. The switchable film according to claim 1, wherein the first cut out portion of the first substrate has a width of from 10 mm to 15 mm.

19. The switchable film according to claim 1, further comprising a first connector attached to the first busbar and a second connector attached to the second busbar.

20. A laminated glazing comprising: a first glass sheet;
a first adhesive interlayer;
a switchable film comprising
a first substrate;
a first conductive layer;
a switchable material layer;
a second conductive layer; and
a second substrate,
wherein the first substrate includes a first cut out portion wherein the first cut out portion aligns entirely with the second substrate;
wherein a first busbar is formed on the first conductive layer on the first substrate and a second busbar is formed on the second conductive layer on the second substrate within the first cut out portion of the first substrate, and
wherein a first barrier is positioned around the first cut out portion of the first substrate;
a second adhesive interlayer; and
a second glass sheet.

21. (canceled)

22. (canceled)

23. (canceled)

24. (canceled)

25. (canceled)

26. (canceled)
